(19) United States
(12) Patent Application Publication
(10) Pub. No.: US 2013/0269868 A1
(43) Pub. Date: Oct. 17, 2013

(54) Method for the production of thermoplastic hollow articles

(71) Applicant: Keutex Textron GmbH & Co. KG, (US)

(72) Inventor: Hans-Georg Neizert, Konigswinter (DE)

(73) Assignee: Keutex Textron GmbH & Co. KG, Bonn (DE)

(21) Appl. No.: 13/694,114

(22) PCT Filed: Mar. 15, 2011
(86) PCT No.: PCT/EP11/01265

§ 371 Date: Jul. 8, 2013

(30) Foreign Application Priority Data
Apr. 27, 2010 (DE) 10 2010 018 527.2

(51) Int. Cl. B29D 22/00

(52) U.S. Cl. CPC B29D 22/00
USPC 156/244.13

(57) ABSTRACT

The invention relates to a method for producing thermoplastic hollow articles, comprising: producing web-shaped or plate-shaped parisons from melted plastic in such a way that the parisons receive a specific wall thickness profile; cooling the parisons to obtain dimensionally stable semifinished products that still have the same wall thickness profile; heating the semifinished products and shaping the heated semifinished products into parts of a hollow article; and welding the semifinished products together to obtain a substantially closed hollow article.

The invention relates to a process for producing hollow bodies made of thermoplastic.

In particular, the invention relates to a process for producing fuel containers made of thermoplastic. Containers of this type generally have a multilayer wall structure made of HDPE with EVOH as barrier layer with respect to hydrocarbon-containing fluids.

Extrusion blow molding is a traditional production process for fuel tanks of this type made of polyethylene. Here, a tubular plastics preform is extruded and, in the molten state, subjected to a forming process within a multipart extrusion blow mold with application of differential pressure, for example through inflation by means of a blowing mandrel, to give the finished container, where the tubular extrudate is brought into contact with the shape of the blow mold during the shaping process within the mold. Gasoline pump, fill-level indicator, sensors, and optionally valves are then subsequently inserted into the tank wall by way of apertures in the blow-molded tank. After incorporation of the components, the apertures are either in turn closed by welding or, in the case of service apertures, are provided with sealed screw caps. The process of subsequent introduction of components into the fuel container is expensive and leads to potential leaks of liquid and/or gaseous hydrocarbons.

A very wide variety of approaches has therefore been disclosed for concomitant introduction of components into the container before production of the container has concluded. By way of example, it is known that, during or after the extrusion process, the tubular plastics preform can be separated along its length and spread to give web-like or sheet-like semifinished products/preforms. This type of process is known by way of example from EP 1 184 157 A1. The process comprises the production of a tubular plastics preform in a blow-molding plant or coextrusion-blow-molding plant, the cutting-open of the extruded or coextruded plastics preform to give at least one sheet-like semifinished product, the thermoforming of the resultant sheet-like semifinished products to give half-shells, and also the welding of the thermoformed half-shells to give a hollow body. In the process of EP 1 184 157 A1, welding of the thermoformed half-shells uses the heat from the thermoforming process.

An advantage of said production process is that, prior to the welding of the thermoformed semifinished products, it is possible optionally to attach inserts such as components of a fuel system without difficulty on the inner side of the half-shells. Another advantage of said process is that the production of the sheet-like semifinished products by way of a blow-molding plant permits targeted and reproducible control of wall thickness for the preforms. However, control of wall thickness during the extrusion of tubular preforms is possible only insofar as uniform and reproducible wall-thickness distribution has been ensured in the tank half-shells. This type of control of the wall thickness in extrusion-blow-molding plants is usually achieved by way of adjustment of the die gap during the extrusion process, and a distinction is made here between what is known as axial wall-thickness control, i.e. in the longitudinal direction of the extrudate, and radial wall-thickness control, i.e. over the periphery of the extrudate. The stream of melt emerging from the extrusion head is distributed over the periphery of the extruded tube, and an inevitable result of this is that the distribution of material becomes interdependent between the two half-shells.

In another production process known in the prior art, what is known as the thermoforming process, two half-shells are first manufactured by thermoforming of appropriate semifinished sheet products, and these are welded to one another in a second step. However, this process has a fundamental disadvantage inter alia in the wall-thickness distribution in the tank half-shells, which is only controllable to a limited extent, for example by way of a temperature profile during the heating process. It is impossible to achieve adequate control of the wall-thickness distribution and therefore of the barrier-layer-thickness distribution, since the semifinished sheet products have a uniform wall thickness, and severe local thinning of the wall or the barrier layer can therefore occur, depending on the stretching ratio during the thermoforming process.

It is an object of the invention to provide a process which can produce hollow bodies made of thermoplastic, in particular large containers, such as fuel containers, and which takes even more account than the processes known hitherto of the problem of wall-thickness distribution on the finished product. A particular intention is that it be possible to obtain preforms or semifinished products of which the walls have genuine “topographies”.

A particular underlying consideration here is that advantageous distributed material in the finished product also contributes to savings in use of the materials, and thus permits particularly inexpensive manufacture. The requirements placed upon lightweight construction are moreover taken into account.

The object is achieved via a process for producing hollow bodies made of thermoplastic, comprising the following steps:
production of web-like or sheet-like preforms made of plastified plastic,
where a specific wall-thickness profile is imposed on each of the preforms,
cooling of the preforms to give dimensionally stable semifinished products with retention of the wall-thickness profile,
heating of the semifinished products and shaping of the heated semifinished products to give portions of a hollow body, and welding of the semifinished products to give a hollow body.

The invention departs in principle from the principle of producing the hollow body by using its initial heat, i.e. by using the heat present in the melt of the extruded preform. Instead, prefabricated semifinished products are produced in a first step and, with reheating and a forming process to give appropriately designed semifinished products, are welded to give a hollow body.

A fundamental advantage of the process of the invention is considered inter alia to be that during the production of the finished hollow bodies, for example during the production of fuel containers, the producer does not have to provide any extrusion equipment. In particular, the extrusion equipment required for the production of large containers takes up a relatively large amount of space, because of the size of the preforms to be produced.

In the invention, the cooling of the preforms to give dimensionally stable semifinished products is preferably followed by trimming/prefabrication of the semifinished products.

A particular advantage of the process is that during production of fuel containers or during production of tanks the tank components can be placed ideally within the tank before the two tank halves are welded to one another. Another particular advantage of the process is that the semifinished products can be produced with a prescribed wall-thickness distribution/topography.

It is preferable that the wall-thickness profile is imposed on the preforms during and/or after the extrusion process.

In a particularly preferred variant, the preforms are extruded by means of an extrusion tool with at least one slot die. A particular advantage of the use of slot dies for the extrusion of sheet-like or web-like preforms is that targeted wall-thickness control is possible across the entire breadth of the preform.

As an alternative, the preforms can be extruded by means of a conventional extrusion head of a conventional extrusion-blow-molding plant or coextrusion-blow-molding plant, where a tubular preform is first extruded, and directly after discharge from the extrusion head or during discharge from the extrusion head is separated along its length at diametrically opposite positions. The separated tube can only then be spread to give two web-like or sheet-like preforms. When the preforms are first produced in the form of tubular extrudate, a wall-thickness profile can be imposed on the preforms by means of known axial and/or radial wall-thickness control.

In principle, the wall-thickness profile of the preforms can at least to some extent be produced by die-gap adjustment during the extrusion process. If extrusion equipment used has slot dies or has straight-linear die gaps it is possible by way of example that a number of segments which are adjustable independently of one another transversely to the direction of extrusion directly restrict the die gap on at least one side and permit stepped adjustment of the width and/or breadth of the die gap. The respective segments can be displaceable elements which can be adjusted transversely to the direction of melt flow by way of individual actuators. Dynamic adjustment of the segments during the extrusion process imposes a wall-thickness profile over the length and/or breadth of the preform.

In the invention, said wall-thickness profile is “frozen in” by cooling of the preforms, thus giving sheet-like semifinished products which are subjected to a forming process after reheating for example by thermoforming to give appropriate half-shells of a plastics container. Welding of the half-shells can be achieved by using the heat from the thermoforming process or else with the aid of known heating elements which heat the half-shells in the region of peripheral flanges for welding purposes.

The prior cooling and freezing-in of the topography of the preforms can be achieved actively with the aid of coolants or else passively at ambient temperature. The wall-thickness profile of the preforms can preferably be produced by subjecting the preforms, after the extrusion process, to a forming process while they are still molten. If a wall-thickness profile is imposed on the preforms after the extrusion process it is possible by way of example for the cooling of the preforms to take place during the forming process.

The preforms are advantageously coextruded in a plurality of layers. In particular in the production of fuel containers as hollow bodies, it is particularly advantageous to coextrude HDPE with EVOH in the form of barrier layer embedded into the HDPE layers. Said barrier layer made of ethylene-vinyl alcohol (EVOH) serves as diffusion barrier for liquid or gaseous hydrocarbons. By way of example, a typical multilayer wall structure can have six layers, where the respective outer layers are composed of HDPE, the barrier layer has been embedded into two adhesion-promoter layers, and what is known as a regrind layer or recyclate layer has been embedded between an adhesion-promoter layer and the outer HDPE layer. In the case of a fuel container, the outer layer of the wall of the container can be made of HDPE pigmented with carbon black. This is adjoined by the following, from the outside to the inside: a regrind layer, an adhesion-promoter layer, an EVOH layer, an adhesion-promoter layer, and an HDPE layer. The inner HDPE layer, mentioned last above, is generally composed of unpigmented virgin polyethylene. The regrind layer comprises constituents of all of the abovementioned layers and is generally composed of recycled waste/flash material arising during the production of the half-shells. By way of example, the trim material arising during the prefabrication of the half-shells is suitable for this purpose.

Wall-thickness distribution of the preforms can, as an alternative or additionally, also be influenced by the application of additional layers during the coextrusion of multilayer preforms. By way of example, a plurality of additional thickening layers can be “superposed” during the extrusion process.

An advantageous variant of the process of the invention subjects the preforms to a forming process by means of profile rolls. By way of example here, web-like or tab-like sheet-like preforms are first extruded by means of one or more slot dies, and a wall-thickness profile is already imposed on the preforms here. These can by way of example be deflected by a take-off device under the extrusion head and transported horizontally between profile rolls, and also cut to length. During passage through the profile rolls, which form a nip, a top( )-graphy is imposed on the preforms by way of the profile rolls in addition to the topography already produced during the extrusion process. An advantage of this additional step is that precisely defined wall-thickness distribution and material distribution is achieved in the preforms, while at the same time cooling of the preforms is already achieved during the forming process by means of profile rolls. This type of cooling will be achieved even if the profile rolls are not cooled, but active cooling of the profile rolls is also within the scope of the invention.

As an alternative to a forming process and, respectively, embossing/profiling the preforms, it is possible in the invention to subject the preforms to a forming process by means of at least one embossing press.

The use of profile rolls/calenders and/or embossing presses permits achievement of what is known as a wall-thickness pattern either only on the upper side or the underside or on both sides of the preforms/sheets. Again when embossing rams or embossing presses are used it is possible that portions of the shaping tools are actively cooled.

The cooling can by way of example also be brought about after or during the forming process via a cooled stream of air, immersion in a waterbath, or transport on a cooled sheetmetal conveyor belt.

A particularly advantageous variant of the process imposes a temperature profile on the ready-to-use semifinished products during the heating process before they are subjected to a forming process to give half-shells. This can be achieved by way of example in that a greater intensity of heating is used at thick points of the semifinished product, in order to achieve uniform stretching of the semifinished product subjected to a forming process by way of example in a thermoforming mold. In order to support the deformation process, in particular at points with increased wall thickness, mechanical stretching aids can provide the required forces for the desired deformation. Examples of mechanical stretching aids that can be used are rams or displaceable elements.

Another advantageous variant of the process of the invention heats the semifinished products in a plurality of stages, where a heating process and optionally retention at a first lower temperature takes place in a first stage and a heating process to a higher temperature takes place in a second stage.

In particular when multiple-ply or multilayer semifinished products with embedded barrier layers are used, it can be advantageous to use heating in the form of preconditioning or prior temperature adjustment, in order to achieve maximum uniformity of temperature over the entire thickness of the semifinished product at every point, thus also ensuring uniform stretching of all of the layers of the semifinished product, including in particular the EVOH layer, when the semifinished product is subjected to a forming process to give a half-shell.

As already mentioned above, the cooling of the preforms can take place by means of at least one cooling device downstream of the extrusion process. The following may be used: cabinets providing controlled temperature and humidity, cooled transport equipment, or cooled take-off equipment, etc.

A preferred variant of the process of the invention extrudes the preforms downward and transports them horizontally by means of at least one take-off device.

The process of the invention first produces semifinished products for a very wide variety of hollow bodies or fuel containers, and the semifinished products for the upper side of the container and for the underside of the container are different. The invention therefore provides, on the semifinished products, identification means which permit unambiguous classification of the semifinished products during use in thermoforming machines or thermoforming molds. Examples of identification means that can be used are labels, shape markers, RFID tags (radio frequency identification tags) or the like. Shape markers provided can, by way of example also be coding notches which can be sensed mechanically on the edges of the semifinished products.

Precise orientation of the semifinished products in relation to the cavity, and also in relation to the heating apparatus of a thermoforming or forming mold is advantageous in order to permit controlled heating of thick points in the semifinished products before they are subjected to a forming process to give half-shells. To this end, orientation means or orientation aids can be provided additionally on the semifinished products, and these can by way of example be marks detectable optically, color markings, or optical patterns. Recognition of the topography of the “wall-thickness landscape” of the individual semifinished products is also possible. Finally, mechanically detectable marks in the form of shape markers, holes, notches, or elevations or the like are likewise advantageous for this purpose.

The process of the invention is illustrated below by taking an inventive example.

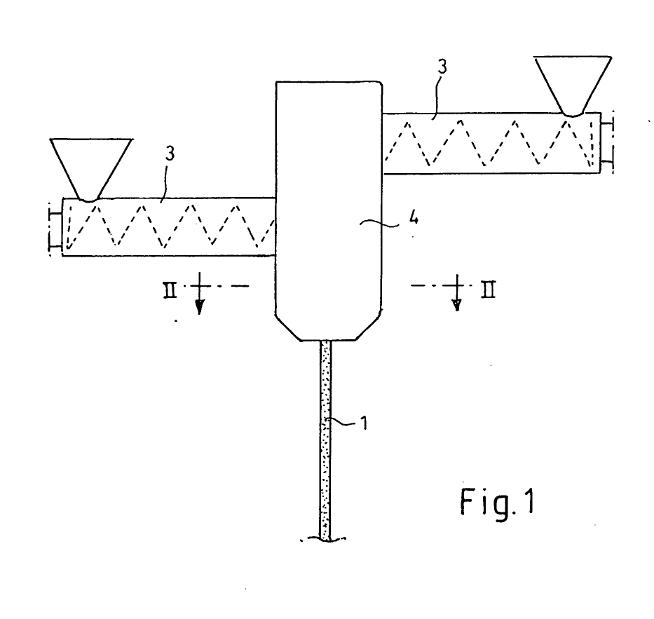

FIG. 1 is a diagram of an extrusion apparatus for producing preforms in the process of the invention.

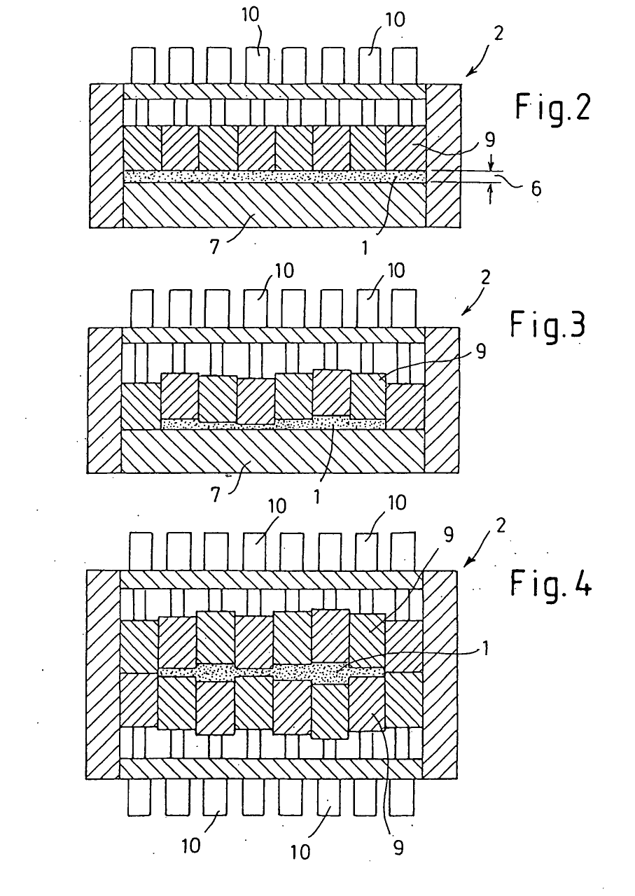

FIGS. 2 and 3 are highly simplified diagrams of cross sections through a slot die which is used in the process of the invention and has adjustable die gap.

FIG. 4 shows a view, as in FIGS. 2 and 3, of a second variant of a slot die.

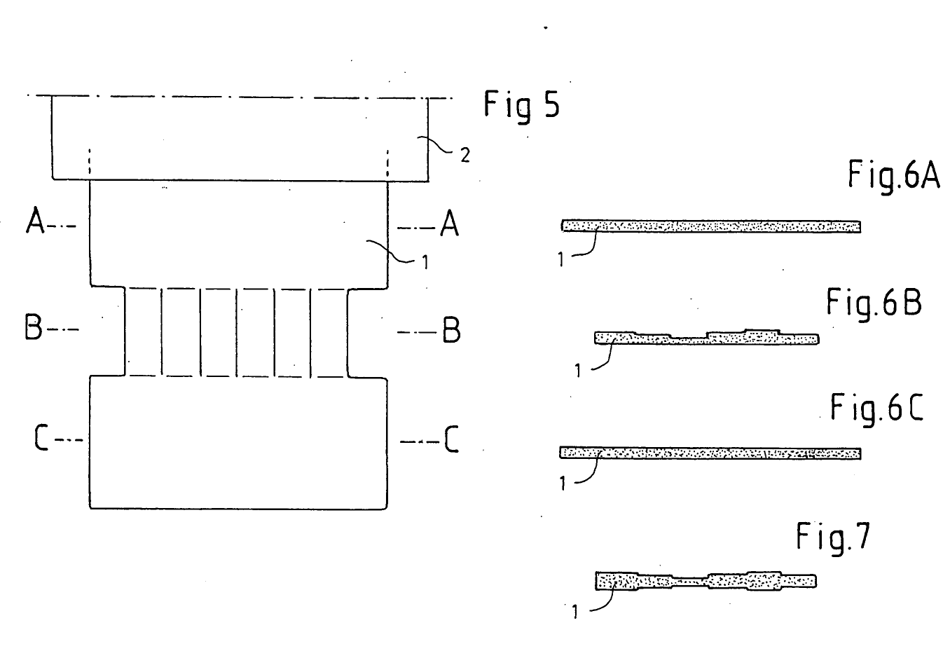

FIG. 5 shows a very exaggerated depiction of a preform emerging from the slot die.

FIGS. 6a to 7 show possible cross-sectional profiles of a preform.

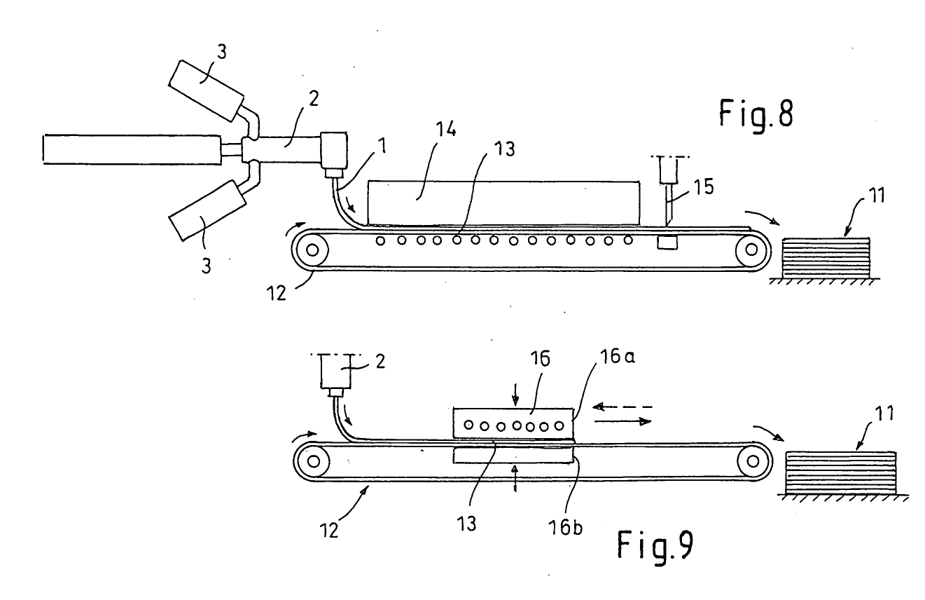

FIG. 8 is a diagram of a first variant of the production process of the invention, omitting the steps of reheating, thermoforming, and welding of the half-shells.

FIG. 9 is a highly simplified diagram of a second variant of the production process of the invention.

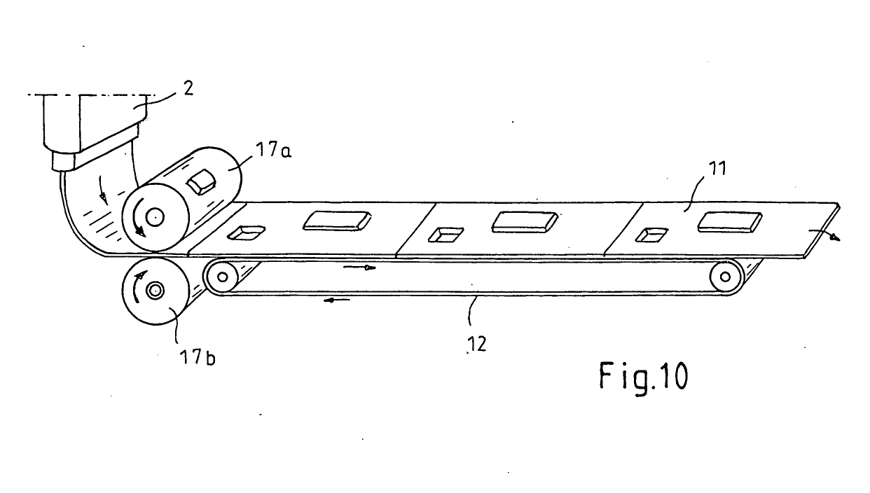

FIG. 10 shows a third variant of the production process of the invention.

The figures are diagrams of a plurality of variants of the production process of the invention. FIG. 1 depicts, merely in the form of indication and with great simplification, an extrusion head 4 of an extrusion system with two screw extruders 3 for plastification and conveying of plastics pellets in a known manner. The screw extruders have been attached radially to the extrusion head 4, within which the plastified thermoplastic material is introduced by way of melt channels into an extrusion die 2 which in the present case is what is known as a slot die. The number of screw extruders 3 attached to the extrusion head 1 is not critical for the invention and depends on the number of the layers to be extruded in the web-like or tab-like preform indicated by 1.

The production of the item or hollow body, in the present case a fuel container made of thermoplastic, comprises firstly the production of web-like sheet-like or tab-like preforms 1 via extrusion in the form of either single-layer or multilayer extrudate with a defined “topography”, the fabrication and cooling of the preforms 1 to give sheet-like semifinished products 11, and also the further processing of the semifinished products 11 to give a finished hollow body or fuel container. The drawings do not depict said further processing of the semifinished products. For this, the semifinished products 11 are reheated in a known apparatus for the thermoforming process and are subjected to a forming process to give half-shells which are welded at flange-like edges to give a finished hollow body, optionally provided with incorporated parts. The incorporated parts to be introduced into the container can be riveted and/or welded in a simple manner on the available inner sides of the half-shells. The heat from the thermoforming process can be used for the welding of the half-shells to give the finished hollow body, and also for the welding and riveting of incorporated parts, but it is also possible for this purpose to introduce additional thermal energy into the semifinished products by means of infrared heating equipment.

A specific wall-thickness distribution or topography can firstly be produced in the process of the invention exclusively during the production of the preform. This wall-thickness distribution can then be frozen in during cooling of the preforms 1. However, as also described in detail below, it is also possible during the process, prior to or during the cooling of the preforms 1, to impose a precisely defined “calibrated” wall-thickness distribution via further mechanical action, preferably via embossing and/or pressing.

Wall-thickness control firstly takes place in the extrusion die 2, as will be explained by using FIGS. 2 to 7. Although it is also possible to produce the preform 1 by using specific wall-thickness distribution (WDC and PWDC) to extrude a tube which is to be cut open at diametrically opposite points, extrusion by means of a slot die is preferred in the process described.

To this end, the die gap 6 of the extrusion die 2 has adjustable width and also adjustable breadth. As can in particular be seen from the sectional views in FIGS. 2 to 4, the die gap 6 is a rectangular-cross-section slot, the breadth of which is much greater than its width.

In the inventive example depicted in FIGS. 2 and 3, the die gap 6 is restricted firstly by a rigid wall section 7 of the die body 8 and secondly by a plurality of segments in the form of displaceable elements 9. The wall section 7 and the displaceable elements 9 respectively delimit the long sides of the die gap 6. The displaceable elements 9 are respectively adjustable by way of actuators 10 transversely with respect to the direction of extrusion, and specifically independently of one another, and it is therefore possible to impose a profile, for example stepped, on the relevant preform.

Although the die gap therefore has a stepped cross section, it has been found, surprisingly, that the flow behavior of the plastified material is such that these steps or discontinuous wall-thickness changes are not replicated in the form of sharp transitions on the preform.

As already mentioned above, the position of the displaceable elements 9 is influenced by way of actuators during the extrusion process, i.e. dynamically, and it is therefore possible to impose, across the breadth of the preforms 1, a profile (thickness control) which changes along the length of the preforms.

The displaceable elements 9 have been depicted by way of example in FIG. 2 in the fully open neutral position, whereas by way of example in FIG. 3 the displaceable elements delimiting the outer ends of the die gap 6 are in their fully closed stop position. By this method it is likewise possible to influence the breadth of the die gap 6, and it is thus possible, as depicted by way of example in exaggerated fashion in FIG. 5, to produce preforms 1 with narrowed or contracted sections (B).

The preform 1 shown in FIG. 5 has, along its length, three successive sections A, B, and C, where in relation to sections A and C section B has less breadth or is contracted. The extrusion die described here has no superposed or separate main gap adjustment system which acts across the entire breadth of the die gap 6. However, there can equally be this type of superposed main gap adjustment system. All of the displaceable elements 9 can be actuated independently of one another.

FIG. 4 depicts a variant of the extrusion die in which the displaceable elements directly delimit both long sides of the die gap, and it is therefore possible to impose a wall-thickness profile on the preform in such a way that this has two profiled outer sides, depicted by way of example in the sectional view in FIG. 7. This method can particularly advantageously produce a preform which has complex topography varying across the length and breadth on both of its large outer surfaces. The breadth of the die gap is moreover also adjustable in relation thereto, as depicted in FIG. 4. The displaceable elements 9 can be moved sectionally inward against one another, and a preform as depicted in FIG. 5 can therefore also be produced in the apparatus of FIG. 4.

As already mentioned above, the resultant topography has no sharp transitions, these also not always being desirable.

The main achievement of the method described above for producing the preforms 1 is that the material is distributed in a form which can be frozen in, as depicted by way of example in FIG. 8, where the arrangement has, below the extrusion head 4, a take-off device in the form of a conveyor belt 12 by which the preforms 1, which are initially extruded in pendant form, i.e. downward, are taken away from the extrusion head 4 horizontally in the direction of conveying of the conveyor belt 12. The conveyor belt 12 is by way of example a sheetmetal conveyor belt, cooled by a heat exchanger 13 arranged between the runs of the conveyor belt 12. The upper run or loadbearing run of the conveyor belt 12 passes through a cooling box 14, which is flushed with cooled air or with a cooling gas. After discharge from the cooling box 14, the preforms 1 are separated by means of a cutting device 15. The points for separation by the cutting device 15 can have been formed in advance as ready-made points of thinning in during the extrusion process via specific die-gap adjustment. The cutting device 15 can by way of example comprise a hot blade or hot wires or the like.

FIG. 9 depicts another variant of the process of the invention, where the preform 1 is likewise taken away from the extrusion head 9 by means of a conveyor belt 12, but where the preform is then introduced into an embossing press 16. In the embossing press 16, which comprises an upper ram 16a and a lower ram 16b, a defined and calibrated topography is imposed on the preform 1. This can be achieved without significant wall-thickness control during the extrusion process, or else in addition to wall-thickness control and wall-thickness distribution during an extrusion process. An embossment can be imposed on one side of the preform here, or else on both sides. In the inventive example described, the upper ram 16a has a heat exchanger 13, and cooling and embossing therefore take place in one step here. Cooling and embossing can, of course, be decoupled from one another.

FIG. 10 depicts another inventive example, where an embossing device takes the form of two profile walls 17a, 17b delimiting a nip through which the preform 1 is passed. In the inventive example described, both rolls are profile rolls 17a, 17b, but it is clear to the person skilled in the art that it is also possible that only one of the rolls is a profile roll. After leaving the nip, the preform 1, having been subjected to a forming process, is taken away by way of a conveyor belt 12, and the cooling and separation of the preforms 1 to give storable semifinished products 11 then follows.

Before the semifinished products 11 are placed in storage, they can be subjected to fabrication in the sense of trimming.

The prefabricated semifinished products are then reheated, plastified, and subjected to a forming/shaping process. These are then welded to give finished fuel containers, and between the shaping/forming process here incorporated parts are optionally attached to the inner sides that are to face toward one another in the semifinished products.

### KEY

1 Preform
2 Extrusion die
3 Screw-based extruder
4 Extrusion head
6 Die gap
7 Wall section
8 Die body
9 Displaceable element
10 Actuators
11 Semifinished products
12 Conveyor belt
13 Heat exchanger
14 Cooling box
15 Cutting device
16 Embossing press
16a Upper ram
16b Lower ram
17a,b Profile rolls

1. A process for producing hollow bodies made of thermoplastic, comprising the following steps:
production of sheet-like preforms made of plastified plastic,
where a specific wall-thickness profile is imposed on each of the preforms,
cooling of the preforms to give dimensionally stable semifinished products with retention of the wall-thickness profile,
heating of the semifinished products and shaping of the heated semifinished products to give portions of a hollow body, and
welding of the semifinished products to give an in essence closed hollow body.

2. The process as claimed in claim 1, characterized in that the preforms are produced by extrusion of plastified plastic.

3. The process as claimed in claim 1, characterized in that the wall-thickness profile is imposed on the preforms during and/or after the extrusion process.

4. The process as claimed in claim 1, characterized in that the preforms are extruded by means of at least one extrusion tool with at least one slot die.

5. The process as claimed in claim 1, characterized in that the wall-thickness profile of the preforms is at least to some extent produced by die-gap adjustment during the extrusion process.

6. The process as claimed in claim 1, characterized in that the wall-thickness profile of the preforms is at least to some extent produced by subjecting the preforms while still molten to a forming process after the extrusion process.

7. The process as claimed in claim 6, characterized in that the cooling of the preforms takes place during the forming process.

8. The process as claimed in claim 1, characterized in that the preforms are coextruded in a plurality of layers.

9. The process as claimed in claim 1, characterized in that wall-thickness distribution of the preforms is influenced by application of additional layers during the extrusion process.

10. The process as claimed in claim 6, characterized in that the preforms are subjected to a forming process by means of at least one profile roll.

11. The process as claimed in claim 6, characterized in that the preforms are subjected to a forming process by means of at least one embossing press.

12. The process as claimed in claim 1, characterized in that a temperature profile is imposed on the semifinished products during the heating process.

13. The process as claimed in claim 1, characterized in that the semifinished products are heated in a plurality of stages, where a heating process and optionally retention at a first lower temperature takes place in a first stage and a heating process to a second higher temperature takes place in a second stage.

14. The process as claimed in claim 1, characterized in that the cooling of the preforms takes place by means of at least one cooling device downstream of the extrusion process.

15. The process as claimed in claim 1, characterized in that the preforms are extruded downward and are transported horizontally by means of at least one take-off device.
